(19) United States
(12) Patent Application Publication
(10) Pub. No.: US 2022/0374050 A1
(43) Pub. Date: Nov. 24, 2022

(54) DISPLAY APPARATUS

(71) Applicant: Masanari Shimamoto, Kanagawa (JP)

(72) Inventor: Masanari Shimamoto, Kanagawa (JP)

(73) Assignee: Ricoh Company, Ltd., Tokyo (JP)

(21) Appl. No.: 17/660,044

(22) Filed: Apr. 21, 2022

(30) Foreign Application Priority Data
May 21, 2021 (JP) 2021-086095

(51) Int. Cl. G06F 1/16

(52) U.S. Cl. CPC G06F 1/1656

(57) ABSTRACT

A display apparatus includes a display, a rear cover covering a rear face of the display, and a reinforcing member disposed between the display and the rear cover. The reinforcing member includes a base, a plurality of projections protruding from the base to the display, each of the plurality of projections having a top face disposed at a position in contact with or in proximity to the display, and a plurality of recessed portions respectively enclosed by the plurality of projections and recessed from the top face.

### CROSS-REFERENCE TO RELATED APPLICATIONS

This patent application is based on and claims priority pursuant to 35 U.S.C. §119(a) to Japanese Patent Application No. 2021-086095, filed on May 21, 2021, in the Japan Patent Office, the entire disclosure of which is hereby incorporated by reference herein.

### BACKGROUND

### Technical Field

The present disclosure relates to a display apparatus.

### Related Art

There are information display apparatuses using a flat panel display that is thin and light. Conventionally, such information display apparatuses have a configuration for reinforcing the flat panel display.

These information display apparatuses include a display that is flexible, and a restriction part that has a plurality of projections and restricts a bending amount of the display.

### SUMMARY

In one aspect, a display apparatus includes a display, a rear cover covering a rear face of the display, and a reinforcing member disposed between the display and the rear cover. The reinforcing member includes a base, a plurality of projections protruding from the base to the display, each of the plurality of projections having a top face disposed at a position in contact with or in proximity to the display, and a plurality of recessed portions respectively enclosed by the plurality of projections and recessed from the top face.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a perspective view of an information display apparatus according to embodiments of the present disclosure;

FIG. 2 is an exploded perspective view of the information display apparatus illustrated in FIG. 1;

FIG. 3 is a back view of an information display of the information display apparatus illustrated in FIG. 1;

FIG. 4 is a back view of the information display of the information display apparatus illustrated in FIG. 1;

FIG. 5 is a front view of a reinforcing member of the information display apparatus according to a first embodiment of the present disclosure;

FIG. 6 is a partial cross-sectional view of the reinforcing member of the information display apparatus taken along line I-I of FIG. 5;

FIG. 7 is a front view of a reinforcing member of the information display apparatus according to a second embodiment of the present disclosure;

FIG. 8 is a front view of a variation of the reinforcing member of the information display apparatus according to the second embodiment;

FIG. 9 is a front view of a reinforcing member of the information display apparatus according to a third embodiment of the present disclosure;

FIG. 10 is a front view of a variation of the reinforcing member of the information display apparatus according to the third embodiment;

FIG. 11 is a front view of a reinforcing member of the information display apparatus according to a fourth embodiment of the present disclosure;

FIG. 12 is a front view of a variation of the reinforcing member of the information display apparatus according to the fourth embodiment;

FIG. 13 is a front view of a reinforcing member of the information display apparatus according to a fifth embodiment of the present disclosure;

FIG. 14 is a front view of a variation of the reinforcing member of the information display apparatus according to the fifth embodiment;

FIG. 15 is a front view of a reinforcing member of the information display apparatus according to a sixth embodiment of the present disclosure;

FIG. 16 is a front view of a variation of the reinforcing member of the information display apparatus according to the sixth embodiment;

FIG. 17 is a schematic view illustrating an example of attachment of a reinforcing member of the information display apparatus according to a seventh embodiment of the present disclosure;

FIG. 18 is a schematic view illustrating the example of the attachment of the reinforcing member of the information display apparatus according to the seventh embodiment;

FIG. 19 is a schematic view illustrating another example of the attachment of the reinforcing member of the information display apparatus according to the seventh embodiment;

FIG. 20 is a schematic view illustrating an example of attachment of a reinforcing member of the information display apparatus according to an eighth embodiment of the present disclosure; and

FIG. 21 is a schematic view illustrating the example of the attachment of the reinforcing member of the information display apparatus according to the eighth embodiment.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, embodiments of the present disclosure are described with reference to the drawings. In the following description of embodiments and the drawings, the same reference numbers are allocated to elements (members or components) having the same or substantially the same function and redundant descriptions thereof are omitted.

Further, in order to facilitate understanding, the scale of each part in the drawing may differ from the actual scale. In the directions such as parallel, right angle, orthogonal, horizontal, vertical, up and down, and lateral directions, a deviation is allowed to the extent that does not impair the effect of embodiments of the present disclosure. The shape of a corner is not limited to a rectangular shape, and may be rounded into an arcuate shape. The terms parallel, right-angled, orthogonal, horizontal, and vertical may include substantially parallel, substantially right-angled, substantially orthogonal, substantially horizontal, and substantially vertical, respectively.

Information Display Apparatus

A description is given of a configuration of the information display apparatus common to embodiments of the present disclosure.

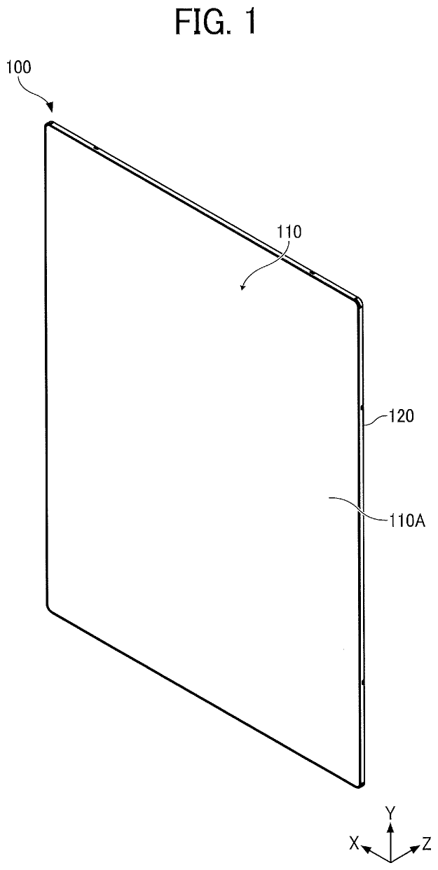

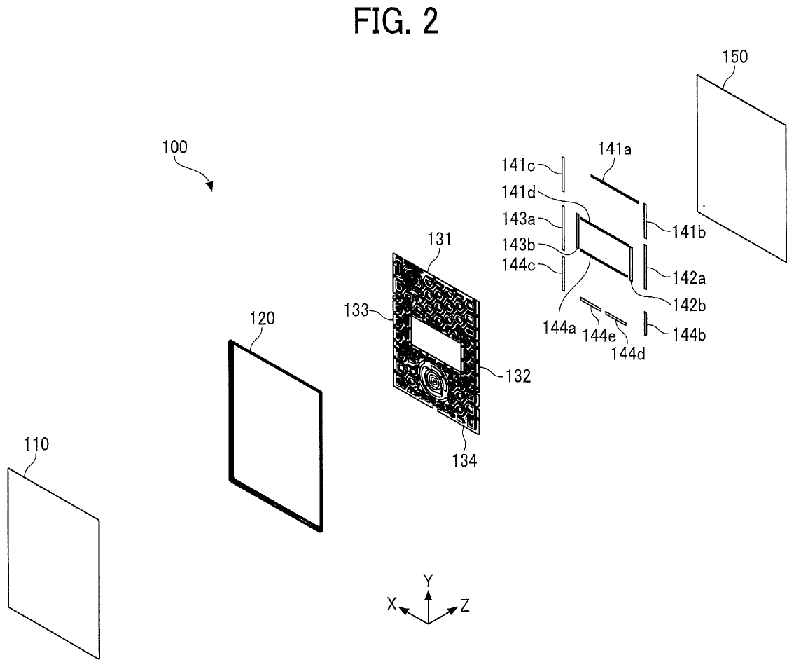

FIG. 1 is a perspective view of an information display apparatus 100 according to embodiments of the present disclosure. FIG. 2 is an exploded perspective view of the information display apparatus 100 according to the embodiments of the present disclosure.

For convenience of explanation, a virtual three-dimensional coordinate system (XYZ Cartesian coordinate system) including an X-axis, a Y-axis, and a Z-axis that are orthogonal to each other may be set in the drawings. The coordinate system is defined for the sake of explanation, and does not limit the posture of the information display apparatus 100 or the like.

In the present disclosure, unless otherwise specified, the X-axis direction is a direction parallel to a screen 110A of the information display apparatus 100, and is a short-side direction of the screen 110A. The Y-axis direction is a direction parallel to the screen 110A of the information display apparatus 100, and is a longitudinal direction of the screen 110A. In other words, the XY plane parallel to the X-axis direction and the Y-axis direction is a plane parallel to the screen 110A of the information display apparatus 100. The Z axis extends in a direction perpendicular to the X and Y axes. In other words, the YZ plane parallel to the Y-axis direction and the Z-axis direction is a plane perpendicular to the screen 110A of the information display apparatus 100. Similarly, the ZX plane parallel to the X-axis direction and the Z-axis direction is a plane perpendicular to the screen 110A of the information display apparatus 100.

The X-axis direction may be referred to as a lateral direction, the Y-axis direction may be referred to as a vertical direction, and the Z-axis direction may be referred to as a thickness direction. Further, the +X side and the −X side with respect to a target may be referred to as the left side and the right side, respectively. Similarly, the +Y side and the −Y side with respect to a target may be referred to as the upper side and the lower side, respectively, and the +Z side and the −Z side with respect to a target may be referred to as the back side (or rear side) and the front side, respectively. In some cases, viewing the information display apparatus 100 from the −Z side is referred to as viewing from the front side. In some cases, viewing the information display apparatus 100 from the +Z side is referred to as viewing from the back side.

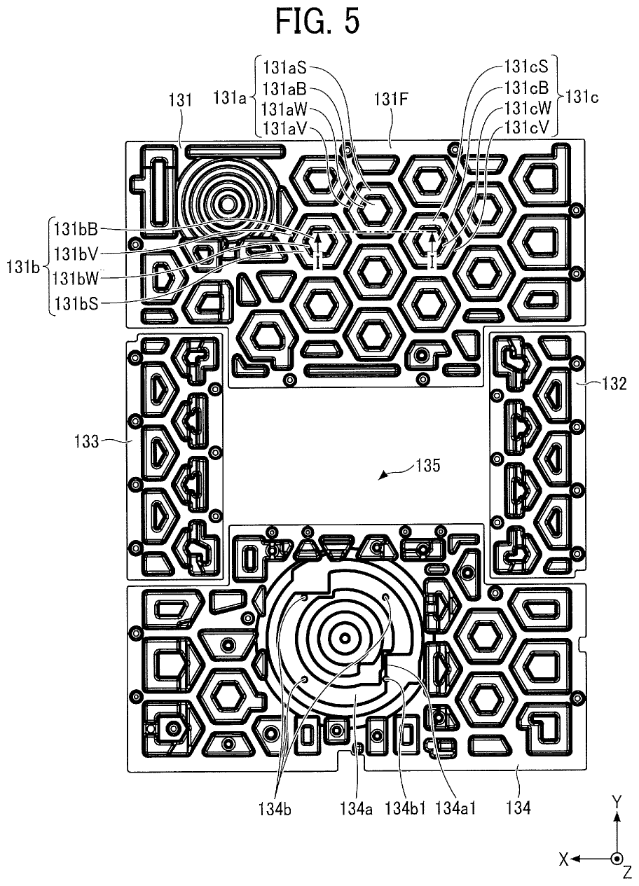

The information display apparatus 100 includes an information display 110, a support frame 120, a reinforcing member 131, a reinforcing member 132, a reinforcing member 133, a reinforcing member 134, and a rear cover 150. Double-sided adhesive tapes 141a, 141b, 141c, 141d, 142a, 142b, 143a, 143b, 144a, 144b, 144c, and 144d are described later with reference to FIG. 5.

The information display apparatus 100 displays a screen image of a personal computer (PC) or the like. Further, users can freely write letters and draw illustrations on the information display 110 using a dedicated pen-type input device. As one feature, the information display apparatus 100 according to the present embodiment is thin as illustrated in FIG. 1. The information display apparatus 100 according to the present embodiment is thin and light. An aspect of the present disclosure enables production of large display products (large in inches) with excellent portability.

Further, as another feature, in the information display apparatus 100 according to the present embodiment, the entire back face is flat as illustrated in FIGS. 1 and 2. Accordingly, for example, the information display apparatus 100 can be placed flat on a desk, and a plurality of viewers can have a discussion surrounding the information display apparatus 100. In addition, the information display apparatus 100 can accept inputs with a plurality of pen-type input devices so that a plurality of users can write at the same time. Further, both the main body of the information display apparatus 100 and the pen-type input device are dustproof and waterproof so that the information display apparatus 100 can be used outdoors.

Information Display

The information display 110 is a so-called display, specifically a flat panel display. The information display 110 includes the screen 110A constructed of pixels for performing display. The screen 110A is parallel to the XY plane of the XYZ Cartesian coordinate system in the drawings.

In the present disclosure, each element of the information display apparatus 100 is specified by using the right side, the left side, the upper side, and the lower side as viewed from the front, but such positional expressions are used for the sake of explanation and do not limit the posture of the information display apparatus 100. For example, the information display apparatus 100 may be placed in a horizontal posture. Alternatively, the information display apparatus 100 may be placed in a different direction by being rotated. This also applies to the subsequent descriptions.

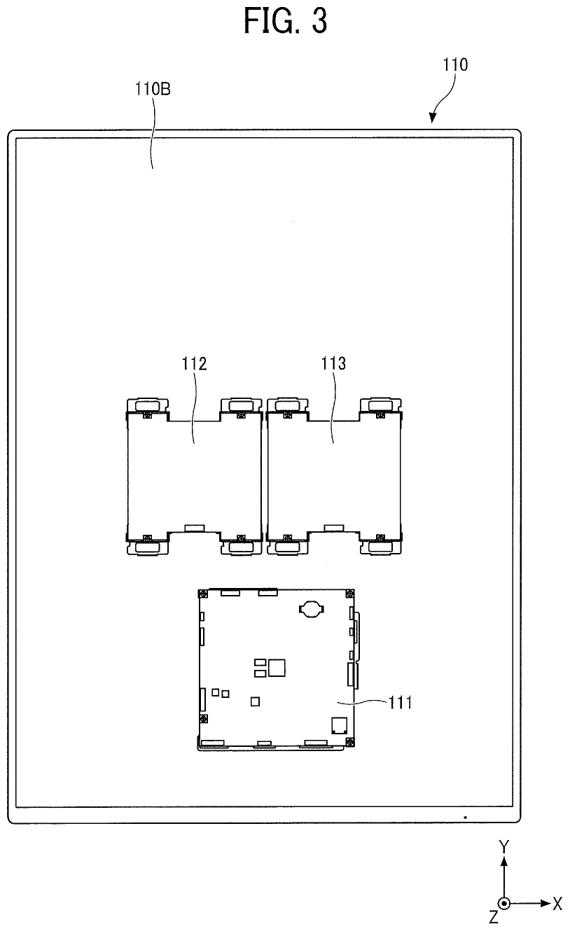

FIG. 3 is a back view of the information display 110 of the information display apparatus 100 according to the embodiments of the present disclosure. The information display 110 includes a rear board 110B (i.e., a rear face of the information display 110) that includes a board 111 that is a circuit board for controlling screen display, a battery 112, and a battery 113.

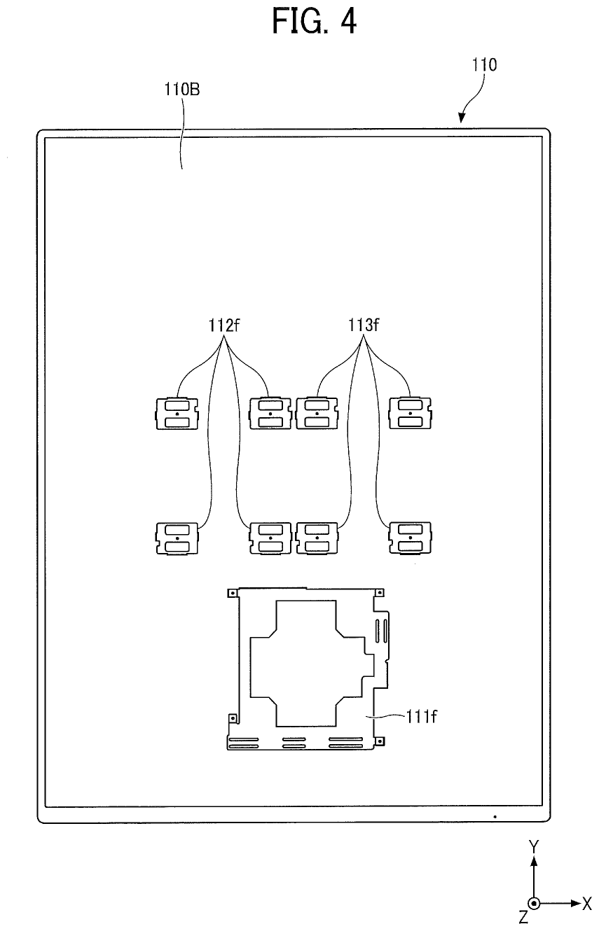

FIG. 4 is the back view of the information display 110 of the information display apparatus 100 according to the embodiments of the present disclosure when the board 111, and the batteries 112 and 113 are removed from the rear board 110B of the information display 110.

The information display 110 includes a bracket 111f for mounting the board 111 on the rear board 110B. The bracket 111f holds the board 111 by screwing or the like.

The information display 110 includes four brackets 112f for mounting the battery 112 on the rear board 110B. The four brackets 112f hold the battery 112 by screwing or the like. The information display 110 includes four brackets 113f for mounting the battery 113 on the rear board 110B. The four brackets 113f hold the battery 113 by screwing or the like.

Support Frame

Referring to FIG. 2, the support frame 120 holds the information display 110 and the rear cover 150. The support frame 120 is a frame having a substantially rectangular shape in the front view. The support frame 120 supports the information display 110 on the front side. The support frame 120 supports the rear cover 150 on the rear side.

### First Embodiment

Reinforcing Members

FIG. 5 is a front view of the reinforcing members 131, 132, 133, and 134 of the information display apparatus 100 according to a first embodiment of the present disclosure. The information display apparatus 100 includes four reinforcing members, specifically, the reinforcing member 131, the reinforcing member 132, the reinforcing member 133, and the reinforcing member 134. The reinforcing members 131, 132, 133, and 134 are disposed between the information display 110 and the rear cover 150. Each of the reinforcing members 131, 132, 133, and 134 is a thin plate and has a plurality of projections on the front side.

Each of the reinforcing members 131, 132, 133, and 134 is formed of, for example, a flame-retardant resin. Each of the reinforcing members 131, 132, 133, and 134 has a plate thickness of, for example, 0.5 mm or more.

Each of the reinforcing members 131, 132, 133, and 134 is fixed to the rear cover 150 with a double-sided adhesive tape, which is described later.

The reinforcing member 131 is positioned above the center of the information display apparatus 100 in the front view. Each of the double-sided adhesive tapes 141a, 141b, 141c, and 141d fixes the reinforcing member 131 to the rear cover 150.

The reinforcing member 132 is positioned in an area closer to the right end than the center of the information display apparatus 100 in the front view. The reinforcing member 132 is positioned between the reinforcing member 131 and the reinforcing member 134 in the vertical direction in the front view. Each of the double-sided adhesive tapes 142a and 142b fixes the reinforcing member 132 to the rear cover 150.

The reinforcing member 133 is positioned in an area closer to the left end than the center of the information display apparatus 100 in the front view. The reinforcing member 133 is positioned between the reinforcing member 131 and the reinforcing member 134 in the vertical direction in the front view. Each of the double-sided adhesive tapes 143a and 143b fixes the reinforcing member 133 to the rear cover 150.

The reinforcing member 134 is positioned below the center of the information display apparatus 100 in the front view. Each of the double-sided adhesive tapes 144a, 144b, 144c, 144d, and 144e fixes the reinforcing member 134 to the rear cover 150.

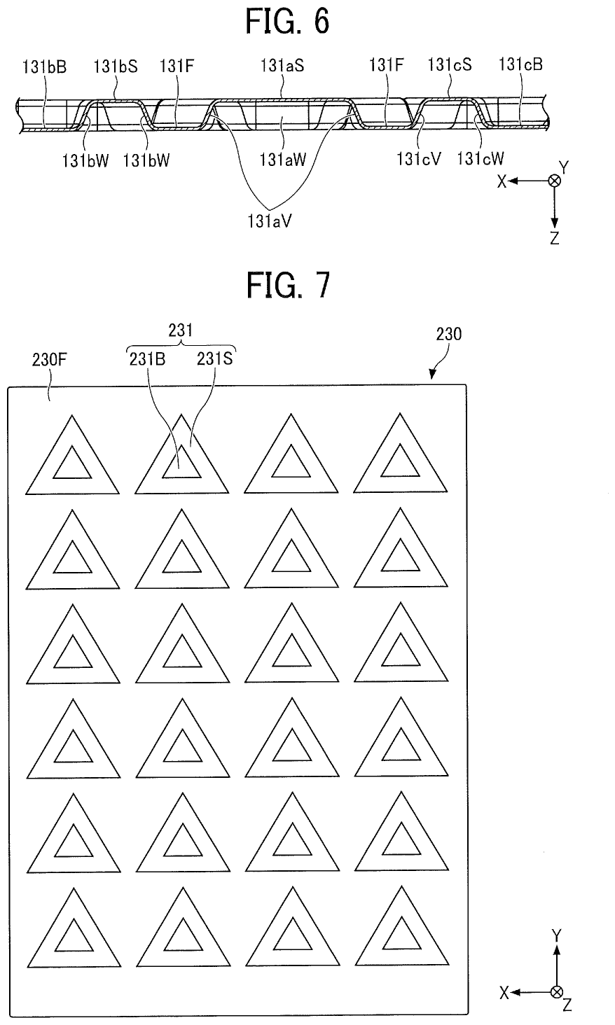

The plurality of projections of the reinforcing members 131, 132, 133, and 134 is described using the reinforcing member 131 as an example. FIG. 6 is a partial cross-sectional view of the reinforcing member 131 of the information display apparatus 100 according to the first embodiment. Specifically, FIG. 6 is a cross-sectional view taken along line I-I of FIG. 5.

The reinforcing member 131 has a base 131F and the plurality of projections. Here, a description is given of projections 131a, projections 131b, and projections 131c. Each of the projections 131a, 131b, and 131c has a hexagonal shape in the front view.

As illustrated in FIG. 5, the projection 131a has a top face 131aS positioned closer to the front end of the information display apparatus 100 than the base 131F and a bottom face 131aB (recessed portion) positioned at substantially the same height as the base 131F. The bottom face 131aB is located on an inner side of the top face 131aS in the front view. The bottom face 131aB has a substantially hexagonal shape in the front view. The top face 131aS has a substantially hexagonal annular shape in the front view. The projection 131a has an outer face 131aV that couples the base 131F and the top face 131aS. Further, the projection 131a has an inner face 131aW that couples the top face 131aS and the bottom face 131aB.

The top face 131aS is disposed at a position in contact with or in close proximity to the rear board 110B of the information display 110 when the information display apparatus 100 is assembled. The position in close proximity to the rear board 110B of the information display 110 refers to a position that comes into contact with the rear board 110B of the information display 110 when the screen 110A of the information display apparatus 100 is pressed during normal use and the information display 110 is deformed.

Since the bottom face 131aB is located on the inner side of the top face 131aS, the top face 131aS is not a hexagonal flat surface and the inner face 131aW serves as a standing wall. Accordingly, when the rear board 110B of the information display 110 comes into contact with the reinforcing member 131, the top face 131aS with the bottom face 131aB located inside thereof better prevents deformation of the information display 110 than the top face 131aS that is flat.

The same applies to a top face 131bS and a top face 131cS. Similarly, the top faces of the projections of the reinforcing members 131, 132, 133, and 134 are disposed at positions in contact with or in close proximity to the rear board 110B of the information display 110 when the information display apparatus 100 is assembled.

In addition, the bottom face 131aB is disposed at a position in contact with or in close proximity to the rear cover 150 when the information display apparatus 100 is assembled. The position in close proximity to the rear cover 150 refers to a position that comes into contact with the rear cover 150 when the screen 110A of the information display apparatus 100 is pressed during normal use and the information display 110 is deformed.

The same applies to a bottom face 131bB and a bottom face 131cB. Similarly, the bottom faces of the projections of the reinforcing members 131, 132, 133, and 134 are disposed at positions in contact with or in close proximity to the rear cover 150 when the information display apparatus 100 is assembled.

The projection 131bb has the top face 131bS positioned closer to the front end of the information display apparatus 100 than the base 131F and the bottom face 131bB positioned at substantially the same height as the base 131F. The bottom face 131bB is located on an inner side of the top face 131bS in the front view. The bottom face 131bB has a substantially hexagonal shape in the front view. The top face 131bS has a substantially hexagonal annular shape in the front view. The projection 131b has an outer face 131bV that couples the base 131F and the top face 131bS. Further, the projection 131b has an inner face 131bW that couples the top face 131bS and the bottom face 131bB.

The projection 131c has the top face 131cS positioned closer to the front end of the information display apparatus 100 than the base 131F and the bottom face 131cB positioned at substantially the same height as the base 131F. The bottom face 131cB is located on an inner side of the top face 131cS in the front view. The bottom face 131cB has a substantially hexagonal shape in the front view. The top face 131cS has a substantially hexagonal annular shape in the front view. The projection 131c has an outer face 131cV that couples the base 131F and the top face 131cS. Further, the projection 131c has an inner face 131cW that couples the top face 131cS and the bottom face 131cB.

Although one projection 131a, one projection 131b, and one projection 131c are given reference numerals in FIG. 5, projections having a similar shape are the projection 131a, 131b, or 131c, and one disposed between two of these projections is referred to as the projection 131a. The projection 131a is disposed between the projection 131b and the projection 131c and shifted therefrom upward in the front view. Accordingly, the projection 131a, the projection 131b, and the projection 131c are arranged in a honeycomb array.

The sizes of the projections 131a, 131b, and 131c are preferably one-fifteenth or more of the long side of the information display apparatus 100 in length. If the lengths of the standing walls (the inner face and the outer face) are short, a bending moment of the entire information display apparatus 100 are supported by the short standing walls. It may be difficult to support the bending moment with the short standing walls when the information display apparatus 100 is lifted or carried. For this reason, a longer standing wall is preferable to support the bending moment of the entire information display apparatus 100. In consideration of a deflection of the entire information display apparatus 100, it is preferable that the standing walls, that is, the sizes of the projections 131a, 131b, and 131c, are one-fifteenth or more of the long side of the information display apparatus 100 in length.

Further, the distances between adjacent two of the projections 131a, 131b, and 131c are preferably equal to or less than 25 mm so that the screen 110A of the information display apparatus 100 is not locally bent due to writing.

The reinforcing members 131, 132, 133, and 134 surround an opening 135 in the central portion where no reinforcing member exists. The batteries 112 and 113 of the information display apparatus 100 mounted on the rear board 110B are positioned in the opening 135 in the front view. Each of the batteries 112 and 113 contacts the rear cover 150. The contact between the batteries 112 and 113 with the rear cover 150 prevents the screen 110A from deforming even when portions of the screen 110A corresponding to the batteries 112 and 113 are pressed.

The reinforcing member 134 has a board supporting portion 134a. The board supporting portion 134a has projections and recesses which are alternately arranged in a concentric manner. In addition, the board supporting portion 134a has a plurality of contact portions 134b that abuts on or comes into contact with areas where no component of the board 111 is mounted. The reinforcing member 134 further includes a standing wall 134a1 that stands on a base and has a top face lower than a top face of each of the projections. Further, a contact portion 134b1 that is one of the plurality of contact portions 134b is disposed on the standing wall 134a1.

The information display apparatus 100 has an area for the board 111 on the rear board 110B. The reinforcing member 134 contacts the rear cover 150. When the reinforcing member 134 is pressed by the rear cover 150, each of the contact portions 134b (including the contact portion 134b1) abuts or comes into contact with the area of the board 111 where no component of the board 111 is mounted. Even when portions of the screen 110A corresponding to the contact portions 134b are pressed, the contact between the contact portions 134b with the rear cover 150 prevents the screen 110A from coming into contact with the area of the board 111 where components of the board 111 are mounted. Although the information display apparatus 100 according to the first embodiment includes four reinforcing members, the number of reinforcing members is not limited. The information display apparatus 100 may include one reinforcing member, or two or more reinforcing members.

Rear Cover

The rear cover 150 protects the rear board 110B of the information display 110.

In the information display apparatus 100 according to the present embodiment, providing the projections on each of the reinforcing members 131, 132, 133, and 134 increases the rigidity thereof. Fixing each of the reinforcing members 131, 132, 133, and 134 having high rigidity to the rear cover 150 prevents the rear cover 150 from deforming. Preventing the rear cover 150 from deforming results in prevention of the entire information display apparatus 100 from deforming.

For example, it is desirable that a flat panel display of a large-sized information display apparatus used for a digital signage is not deformed during transportation and installation. It is also desirable that a display surface of a flat panel display of an information display apparatus is not deformed when a force is applied to the display surface of the flat panel display.

The top faces of the projections located on the reinforcing members 131, 132, 133, and 134 are disposed at positions in contact with or in close proximity to the rear board 110B of the information display 110 when the information display apparatus 100 is assembled. Accordingly, even when the screen 110A of the information display apparatus 100 is pressed, the top faces of the projections of the reinforcing members 131, 132, 133, and 134 prevent the information display 110 from locally deforming by the contact with the rear board 110B of the information display 110.

Further, having the recessed portions on the inner side of the top faces of the projections located on each of the reinforcing members 131, 132, 133, and 134 increases the rigidity of the top faces of the projections located on each of the reinforcing members 131, 132, 133, and 134. Each of the reinforcing members 131, 132, 133, and 134 having higher rigidity of the top faces further prevents the information display 110 from locally deforming.

According to the present embodiment, preventing the entire information display apparatus 100 from deforming and locally deforming results in prevention of the information display 110 from being damaged.

Hereinafter, a description is given of several variations of the projection of the reinforcing member as second to sixth embodiments. In the drawings, only a top face and a bottom face of the projection are illustrated for simplification.

### Second Embodiment

FIG. 7 is a front view of a reinforcing member 230 of the information display apparatus according to a second embodiment of the present disclosure. The reinforcing member 230 has a plurality of projections 231 having a triangular shape in the front view. Here, a description is given of the projections 231.

The projection 231 has a top face 231S positioned closer to the front end of the information display apparatus 100 than a base 230F and a bottom face 231B (a recessed portion) positioned at substantially the same height as the base 230F. The bottom face 231B has a substantially triangular shape in the front view. The top face 231S has a substantially triangular annular shape in the front view. The projection 231 has an outer face that couples the base 230F and the top face 231S. Further, the projection 231 has an inner face that couples the top face 231S and the bottom face 231B.

The reinforcing member 230 has the projections 231 that are oriented in a same direction and arranged at uniform intervals in the vertical and lateral directions.

Although the projections 231 are oriented in the same direction and arranged uniformly in the vertical and lateral directions in the present embodiment, the arrangement is not limited thereto. For example, one row of the projections 231 oriented in one direction alternates with another row of the projections 231 oriented in the opposite direction.

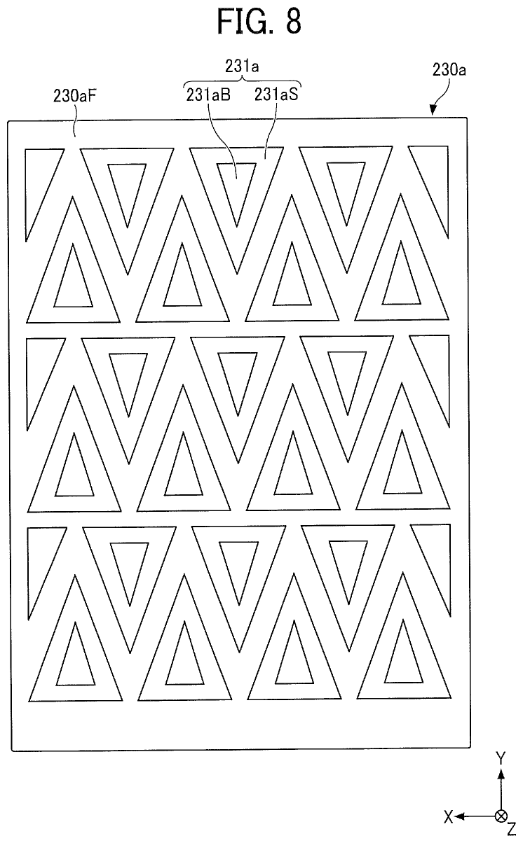

FIG. 8 is a front view of a reinforcing member 230a that is a variation of the reinforcing member 230 of the information display apparatus according to the second embodiment. The reinforcing member 230a has a plurality of projections 231a having a triangular shape in the front view. Here, a description is given of the projections 231a.

The projection 231a has a top face 231aS positioned closer to the front end of the information display apparatus 100 than a base 230aF and a bottom face 231aB positioned at substantially the same height as the base 230aF. The bottom face 231aB has a substantially triangular shape in the front view. The top face 231aS has a substantially triangular annular shape in the front view. The reinforcing member 230a has the projections 231a that are oriented in different directions alternately in every second row.

### Third Embodiment

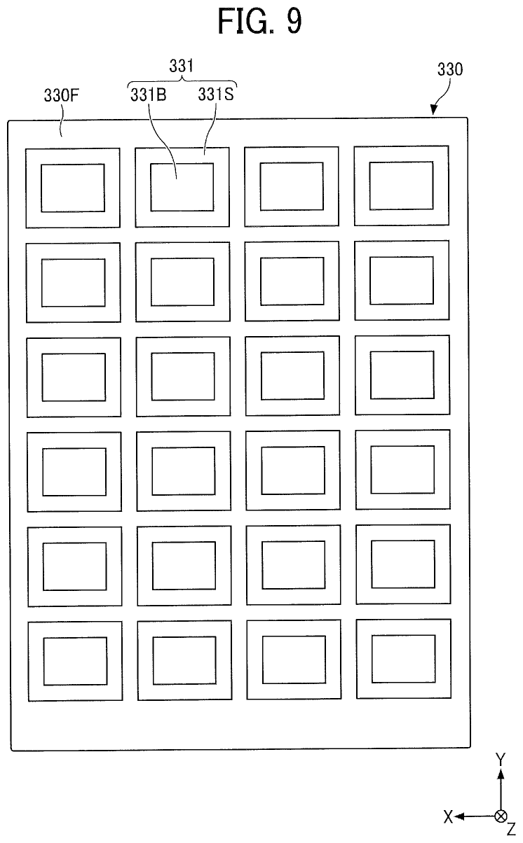

FIG. 9 is a front view of a reinforcing member 330 of the information display apparatus according to a third embodiment of the present disclosure. The reinforcing member 330 has a plurality of projections 331 having a rectangular shape in the front view. Here, a description is given of the projections 331.

The projection 331 has a top face 331S positioned closer to the front end of the information display apparatus 100 than a base 330F and a bottom face 331B positioned at substantially the same height as the base 330F. The bottom face 331B has a substantially rectangular shape in the front view. The top face 331S has a substantially rectangular annular shape in the front view. The projection 331 has an outer face that couples the base 330F and the top face 331S. Further, the projection 331 has an inner face that couples the top face 331S and the bottom face 331B.

The reinforcing member 330 has the projections 331 are arranged uniformly in the vertical and lateral directions.

Although the projections 331 are arranged uniformly in the vertical and lateral directions in the present embodiment, the arrangement is not limited thereto. For example, the lateral position of the projections 331 may be different depending the row.

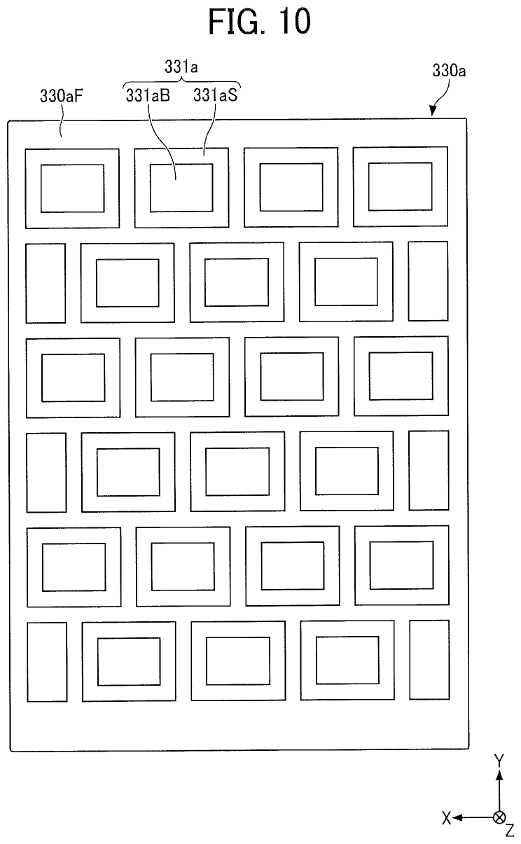

FIG. 10 is a front view of a reinforcing member 330a that is a variation of the reinforcing member 330 of the information display apparatus according to the third embodiment. The reinforcing member 330a has a plurality of projections 331a having a rectangular shape in the front view. Here, a description is given of the projections 331a.

The projection 331a has a top face 331aS positioned closer to the front end of the information display apparatus 100 than a base 330aF and a bottom face 331aB positioned at substantially the same height as the base 330aF. The bottom face 331aB has a substantially rectangular shape in the front view. The top face 331aS has a substantially rectangular annular shape in the front view. The reinforcing member 330a has the projections 331a, and one row of the projections 331a is shifted in the lateral direction alternately with another row of the projections 331a.

### Fourth Embodiment

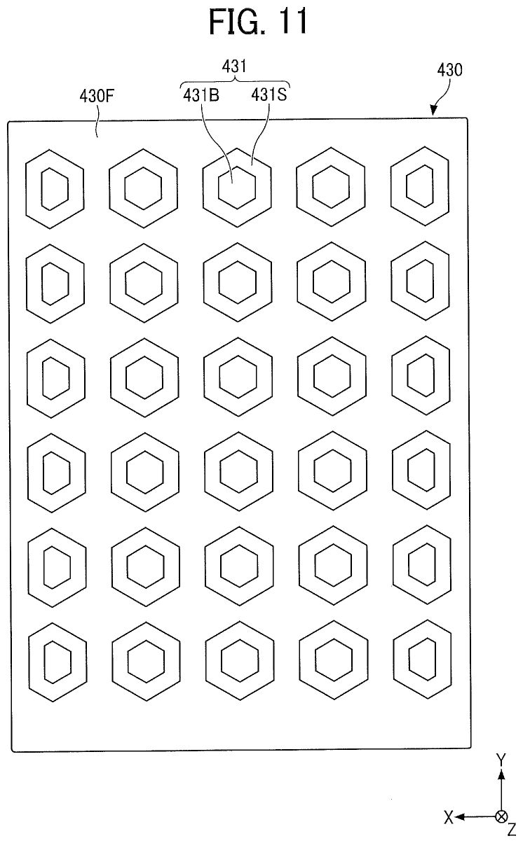

FIG. 11 is a front view of a reinforcing member 430 of the information display apparatus according to a fourth embodiment of the present disclosure. The reinforcing member 430 has a plurality of projections 431 having a hexagonal shape in the front view. Here, a description is given of the projections 431.

The projection 431 has a top face 431S positioned closer to the front end of the information display apparatus 100 than a base 430F and a bottom face 431B positioned at substantially the same height as the base 430F. The bottom face 431B has a substantially hexagonal shape in the front view. The top face 431S has a substantially hexagonal annular shape in the front view. The projection 431 has an outer face that couples the base 430F and the top face 431S. Further, the projection 431 has an inner face that couples the top face 431S and the bottom face 431B.

The reinforcing member 430 has the projections 431 that are arranged uniformly in the vertical and lateral directions.

Although the projections 431 are arranged uniformly in the vertical and lateral directions in the present embodiment, the arrangement is not limited thereto. For example, one row of the projections 431 may be shifted in the lateral direction from another row of the projections 431.

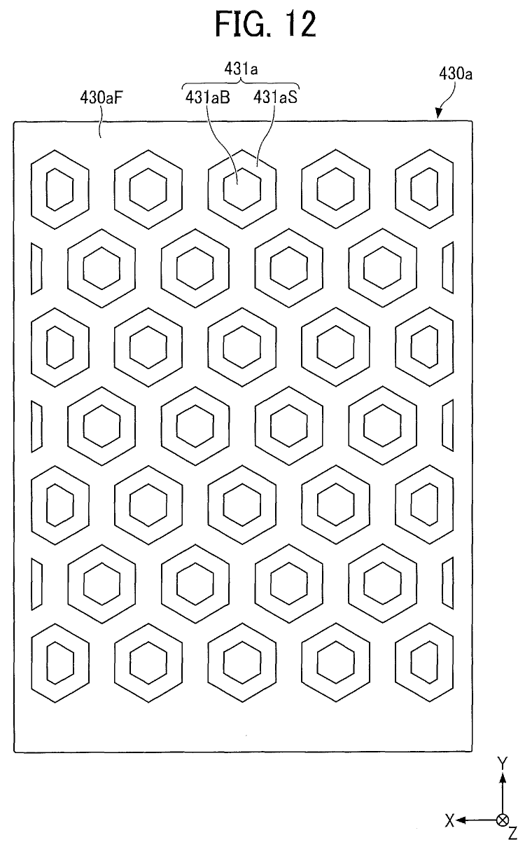

FIG. 12 is a front view of a reinforcing member 430a that is a variation of the reinforcing member 430 of the information display apparatus according to the fourth embodiment. The reinforcing member 430a has a plurality of projections 431a having a hexagonal shape in the front view. Here, a description is given of the projections 431a.

The projection 431a has a top face 431aS positioned closer to the front end of the information display apparatus 100 than a base 430aF and a bottom face 431aB positioned at substantially the same height as the base 430aF. The bottom face 431aB has a substantially hexagonal shape in the front view. The top face 431aS has a substantially hexagonal annular shape in the front view. The reinforcing member 430a has the projections 431a, and one row of the projections 431a is shifted in the lateral direction alternately with another row of the projections 431a.

### Fifth Embodiment

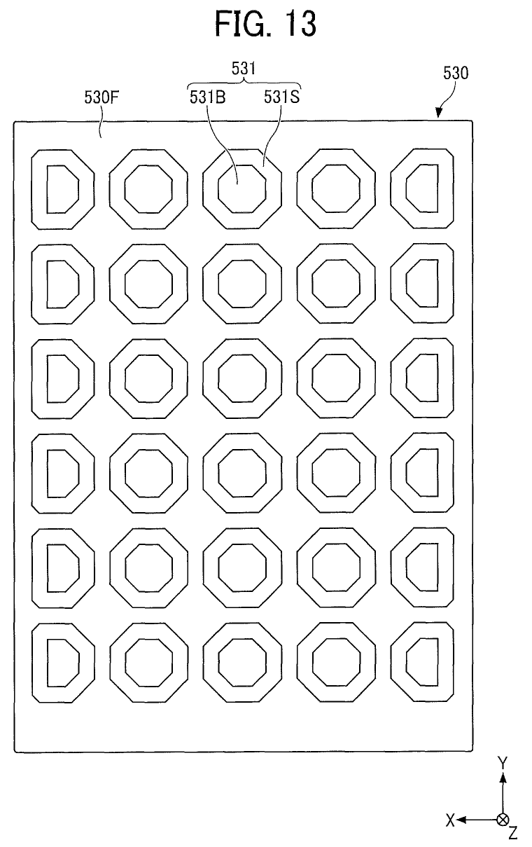

FIG. 13 is a front view of a reinforcing member 530 of the information display apparatus according to a fifth embodiment of the present disclosure. The reinforcing member 530 has a plurality of projections 531 having an octagonal shape in the front view. Here, a description is given of the projections 531.

The projection 531 has a top face 531S positioned closer to the front end of the information display apparatus 100 than a base 530F and a bottom face 531B positioned at substantially the same height as the base 530F. The bottom face 531B has a substantially octagonal shape in the front view. The top face 531S has a substantially octagonal annular shape in the front view. The projection 531 has an outer face that couples the base 530F and the top face 531S. Further, the projection 531 has an inner face that couples the top face 531S and the bottom face 531B.

The reinforcing member 530 has the projections 531 that are arranged uniformly in the vertical and lateral directions.

Although the projections 531 are arranged uniformly in the vertical and lateral directions in the present embodiment, the arrangement is not limited thereto. For example, one row of the projections 531 may be shifted in the lateral direction from another row of the projections 531.

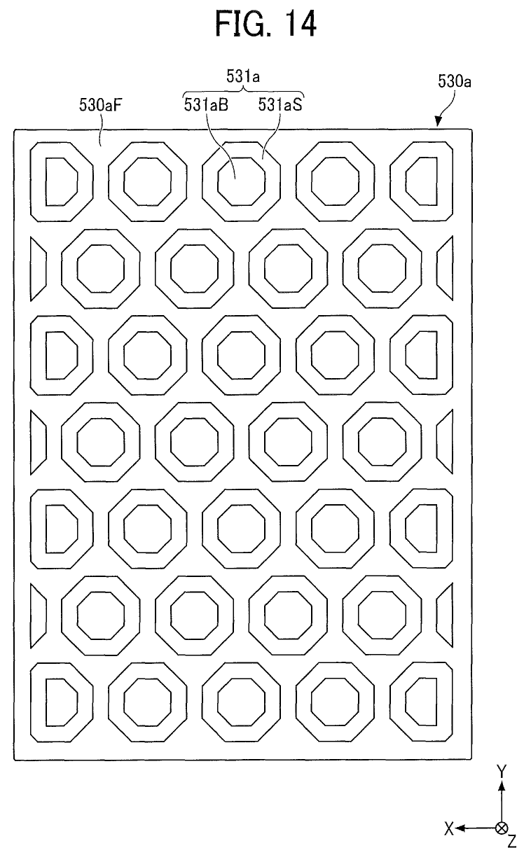

FIG. 14 is a front view of a reinforcing member 530a that is a variation of the reinforcing member 530 of the information display apparatus according to the fifth embodiment. The reinforcing member 530a has a plurality of projections 531a having an octagonal shape in the front view. Here, a description is given of the projections 531a.

The projection 531a has a top face 531aS positioned closer to the front end of the information display apparatus 100 than a base 530aF and a bottom face 531aB positioned at substantially the same height as the base 530aF. The bottom face 531aB has a substantially octagonal shape in the front view. The top face 531aS has a substantially octagonal annular shape in the front view. The reinforcing member 530a has the projections 531a, and one row of the projections 531a is shifted in the lateral direction alternately from another row of the projections 531a.

### Sixth Embodiment

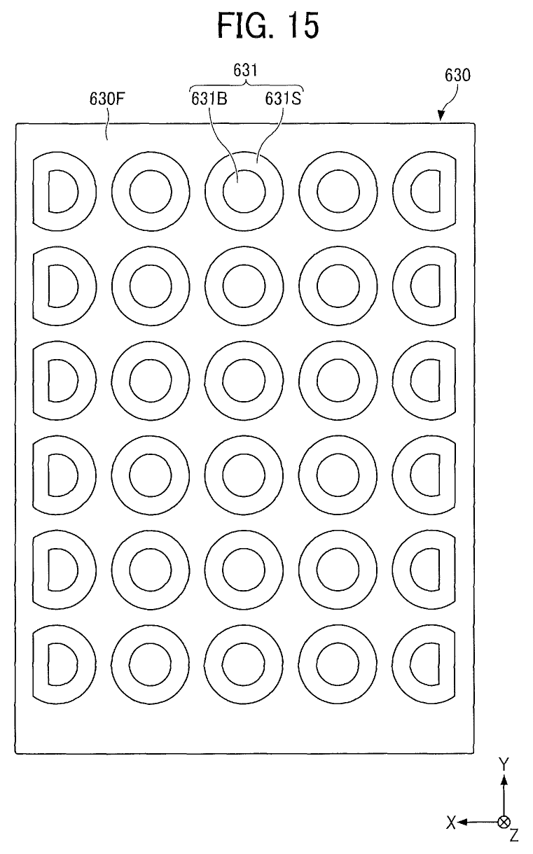

FIG. 15 is a front view of a reinforcing member 630 of the information display apparatus according to a sixth embodiment of the present disclosure. The reinforcing member 630 has a plurality of projections 631 having a circular shape in the front view. Here, a description is given of the projections 631.

The projection 631 has a top face 631S positioned closer to the front end of the information display apparatus 100 than a base 630F and a bottom face 631B positioned at substantially the same height as the base 630F. The bottom face 631B has a substantially circular shape in the front view. The top face 631S has a substantially circular annular shape in the front view. The projection 631 has an outer face that couples the base 630F and the top face 631S. Further, the projection 631 has an inner face that couples the top face 631S and the bottom face 631B.

The reinforcing member 630 has the projections 631 that are arranged uniformly in the vertical and lateral directions.

Although the projections 631 are arranged uniformly in the vertical and lateral directions in the present embodiment, the arrangement is not limited thereto. For example, one row of the projections 631 may be shifted in the lateral direction from another row of the projections 631.

FIG. 16 is a front view of a reinforcing member 630a that is a variation of the reinforcing member 630 of the information display apparatus according to the sixth embodiment. The reinforcing member 630a has a plurality of projections 631a having a circular shape in the front view. Here, a description is given of the projections 631a.

The projection 631a has a top face 631aS positioned closer to the front end of the information display apparatus 100 than a base 630aF and a bottom face 631aB positioned at substantially the same height as the base 630aF. The bottom face 631aB has a substantially circular shape in the front view. The top face 631aS has a substantially circular annular shape in the front view. The reinforcing member 630a has the projections 631a, and one row of the projections 631a is shifted in the lateral direction alternately from another row of the projections 631a.

Although the variations of the projection of the reinforcing member have been described in the second to the sixth embodiments, the shapes of the projection of the reinforcing member are not limited thereto. For example, the shape of the projection of the reinforcing member may be a polygon other than the shapes described above, an ellipse, a rectangle with rounded corners (a shape formed by two parallel lines of equal length and two semicircles), a star, a cross, or the like in the front view.

Further, the arrangements of the projections are not limited to the examples described above. In the region where the projections of the reinforcing members are arranged, it is preferable that the bases are not arranged on a straight line in the vertical direction, for example, like the reinforcing members 430a (FIG. 12), 350a (FIGS. 14), and 630a (FIG. 16).

### Seventh Embodiment

Next, a description is given of attachment of the reinforcing member and the rear cover.

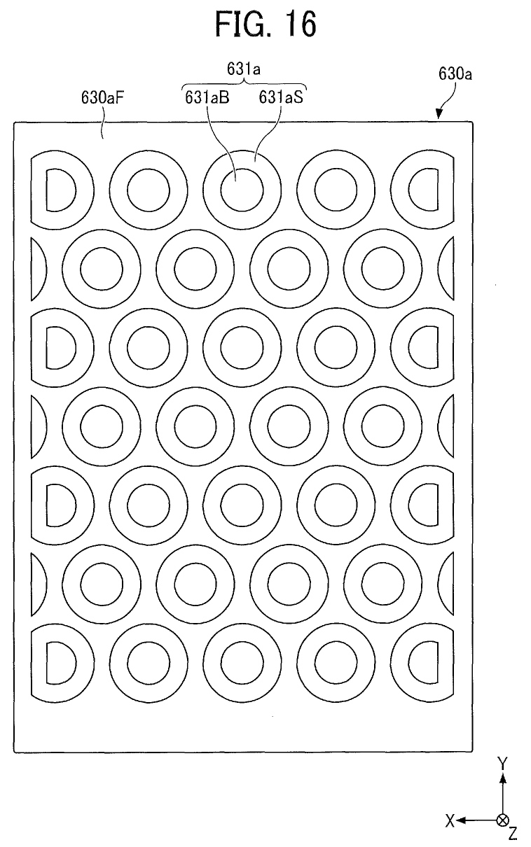

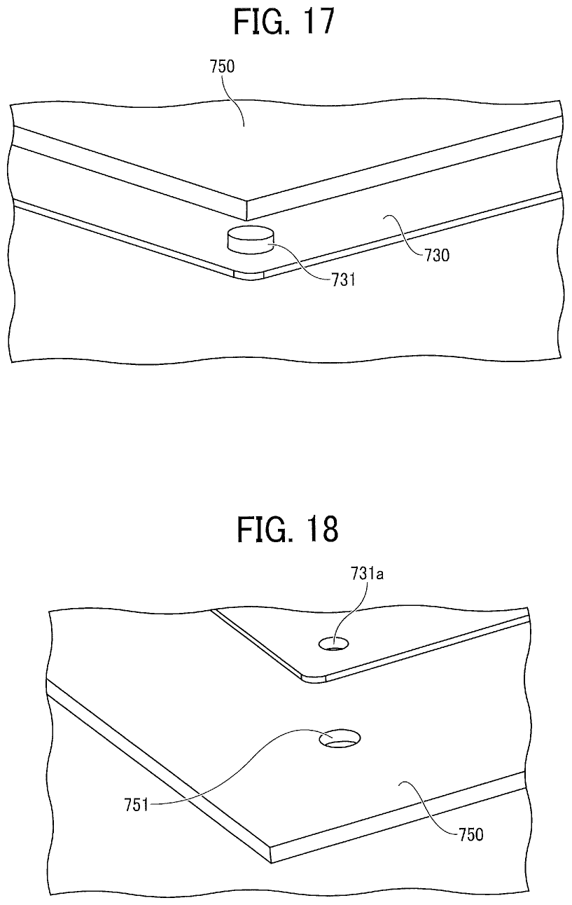

FIGS. 17 and 18 are schematic views illustrating an example of attachment of a reinforcing member 730 of the information display apparatus according to a seventh embodiment of the present disclosure.

The reinforcing member 730 has a protruding portion 731 on the reverse side, that is, the side facing a rear cover 750. The protruding portion 731 has, for example, a cylindrical shape. The protruding portion 731 has a recessed portion 731a on the front side.

The rear cover 750 has a hole 751.

By fitting the protruding portion 731 into the hole 751, the reinforcing member 730 is aligned with and attached to the rear cover 750.

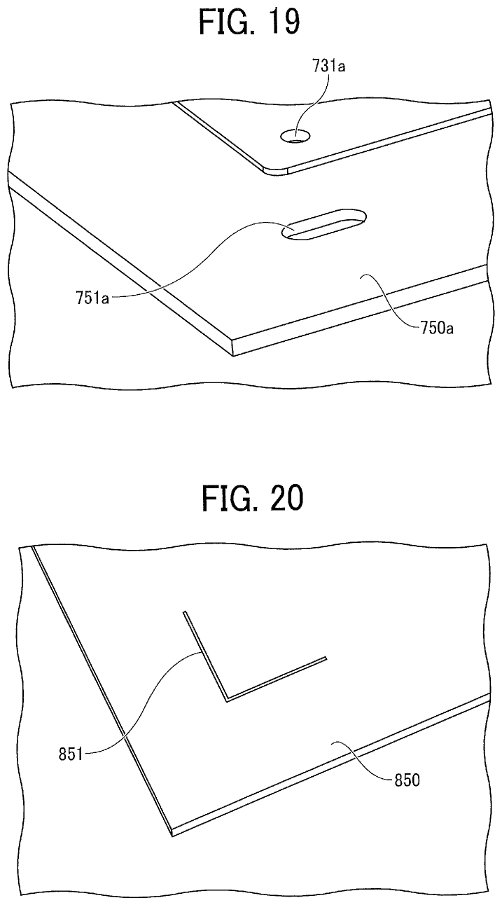

The shape of the hole of the rear cover 750 is not limited to a circle in the front view. For example, as illustrated in FIG. 19, the rear cover may have a hole 751a that is elongated in one direction. Further, the shape of the hole of the rear cover 750 may be a polygon, an ellipse, a rectangle with rounded corners (a figure formed by two parallel lines of equal length and two semicircles), a star, a cross, or the like in the front view. Note that the shape of the hole may be changed in accordance with the shape of the protruding portion.

Further, instead of the protruding portion 731 of the reinforcing member 730, the reinforcing member may have a hole and the rear cover may have a protruding portion.

### Eighth Embodiment

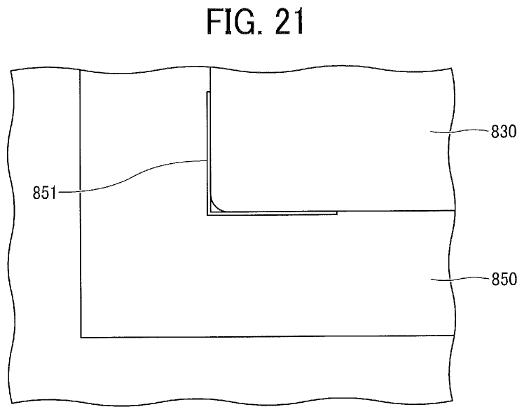

FIGS. 20 and 21 are schematic views illustrating an example of attachment of a reinforcing member 830 of the information display apparatus according to an eighth embodiment of the present disclosure.

A rear cover 850 has a marking 851.

By aligning the corner of the reinforcing member 830 with the marking 851, the reinforcing member 830 is aligned with and attached to the rear cover 850.

The present disclosure is not limited to the configurations of the above-described embodiments, and another element may be combined with the configuration described above. The configuration and combination of elements can be modified without departing from the spirit of the present disclosure, and can be appropriately determined according to the form of application.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A display apparatus comprising:
a display;
a rear cover covering a rear face of the display; and
a reinforcing member disposed between the display and the rear cover, the reinforcing member including:
a base;
a plurality of projections protruding from the base to the display, each of the plurality of projections having a top face disposed at a position in contact with or in proximity to the display; and
a plurality of recessed portions respectively enclosed by the plurality of projections and recessed from the top face.

2. The display apparatus according to claim 1 further comprising:
a board; and
a bracket that mounts the board on the rear face of the display,
wherein:
the reinforcing member includes a contact portion that contacts an empty area of the board, the empty area being free of a component of the board.

3. The display apparatus according to claim 2, wherein:
the reinforcing member further includes a standing wall standing on the base, the standing wall having a top face lower than the top face of each of the plurality of projections; and
the contact portion is located on the standing wall.

4. The display apparatus according to claim 1, wherein:
a size of each of the plurality of projections is one-fifteenth or more of a long side of the display apparatus in length.

5. The display apparatus according to claim 1, wherein:
a distance between adjacent two of the plurality of projections is equal to or less than 25 mm.

6. The display apparatus according to claim 1, wherein:
the rear cover has at least one of a protruding portion, a hole, or a marking indicating a position where the reinforcing member is attached.

7. The display apparatus according to claim 1, wherein:
the reinforcing member includes a flame-retardant resin and has a plate thickness of 0.5 mm or more.
